(19) United States
(12) Patent Application Publication
(10) Pub. No.: US 2024/0048250 A1
(43) Pub. Date: Feb. 8, 2024

(54) WIRELESS COMMUNICATION APPARATUS, WIRELESS COMMUNICATION SYSTEM AND WIRELESS COMMUNICATION METHOD

(71) Applicant: NIPPON TELEGRAPH AND TELEPHONE CORPORATION, Tokyo (JP)

(72) Inventors: Kazumitsu SAKAMOTO, Musashino-shi (JP); Kento YOSHIZAWA, Musashino-shi (JP); Takeshi KINOSHITA, Musashino-shi (JP); Etsushi YAMAZAKI, Musashino-shi (JP); Takayuki MIZUNO, Musashino-shi (JP); Takuya OHARA, Musashino-shi (JP)

(73) Assignee: NIPPON TELEGRAPH AND TELEPHONE CORPORATION, Tokyo (JP)

(21) Appl. No.: 18/266,896

(22) PCT Filed: Dec. 16, 2020
(86) PCT No.: PCT/JP2020/046939

§ 371 Date: Jun. 13, 2023

(51) Int. Cl. H04B 13/02; H04B 10/11

(52) U.S. Cl. CPC H04B 13/02; H04B 10/11

(57) ABSTRACT

An aspect of the present invention is a wireless communication device including a water flow generator that controls a shape of a partial region on a water surface, and
an emission unit that emits a wave carrying information toward the region.

### TECHNICAL FIELD

The present invention relates to a wireless communication apparatus, a wireless communication system, and a wireless communication method.

### BACKGROUND ART

In recent years, there has been an increasing demand for devices that collect information in water such as underwater sensors and autonomous underwater vehicles (AUV) for monitoring underwater environments and marine organisms. Further, a demand for a method of easily collecting data collected in water without floating a device for collecting information in water on the water surface has also been increasing.

Therefore, for example, a technique in which a receiver for receiving information is provided in a flying moving object such as an aerial drone, and information is acquired by using the moving object without floating a device such as an AUV on the water surface has been proposed. More specifically, a technique for transmitting information from underwater to the air using optical wireless communication by making an aerial transceiver which is a moving object provided with a receiver stand by in the air (water-to-air optical wireless communication or W2A-OWC) has been proposed (NPL 1).

### CITATION LIST

### Non Patent Literature

[NPL 1] P. Nabavi, A.F.M.S.Haq and M. Yuksel, “Empirical Modeling and Analysis of Water-to-Air Optical Wireless Communication Channels,” 2019 IEEE International Conference on Communication Workshops (ICC Workshops), pp. 1-6, May 2019.

### SUMMARY OF INVENTION

### Technical Problem

However, the techniques proposed so far have a problem that the longer the distance between the water and the aerial transceiver, the more unstable the communication becomes. This problem results in a burst error, for example, while the aerial transceiver cannot receive sufficient light required for data transmission. The situation in which the aerial transceiver cannot receive sufficient light is caused by the fact that, for example, the longer the distance is, the more the propagation direction of light emitted from an underwater transceiver fluctuates due to fluctuation of the water surface, and thus the intensity of an optical signal received by the aerial transceiver in a unit time decreases. The underwater transceiver is a device for transmitting information to the aerial transceiver, such as an AUV.

To solve such a problem, it has been proposed to reduce the fluctuation of the level of received light due to the fluctuation of the water surface by mounting a plurality of transmitters on an underwater transceiver to achieve transmission diversity. More specifically, it is a technique in which, when the condition that the diameter of a beam formed by light transmitted from a plurality of transmitters is equal to or greater than the wavelength of the water surface is satisfied, stable propagation of light is possible with transmission diversity using the plurality of transmitters. However, the wavelength of waves of the sea is on the meter order. For this reason, an enormous number of transmitters are required to use the proposed technique. That is, to use the proposed technique, the device on the signal transmission side should have an extremely large size.

In this way, the technique of transmitting information using light from underwater to air has a problem that it is difficult to suppress an increase in size of a transmission-side device while stabilizing communication. Further, such a problem is common not only when waves for carrying information from underwater to the air are light, but also when waves for carrying information from underwater to the air are electromagnetic waves such as light or radio waves.

Further, such a problem is a common even when waves for carrying information from underwater to the air are sound waves. Furthermore, such a problem is a common problem not only when the underwater transceiver and the aerial transceiver are moving objects but also when at least one of the underwater transceiver and the aerial transceiver is not a moving object.

In view of the above circumstances, the present invention aims to provide a technique for achieving both improvement in communication stability when information is wirelessly transmitted from underwater to the air and suppression of increase in size of a signal transmission side device.

### Solution to Problem

An aspect of the present invention is a wireless communication device including a water flow generator that controls a shape of a partial region on a water surface, and an emission unit that emits a wave carrying information toward the region.

### Advantageous Effects of Invention

According to the present invention, it is possible to reduce a delay in communication.

### BRIEF DESCRIPTION OF DRAWINGS

FIG. 1 is an explanatory diagram for describing an overview of a communication system 100.

FIG. 2 is a diagram illustrating an example of an enlarged view of a water surface convex portion in an embodiment.

FIG. 3 is a diagram illustrating an example of a hardware configuration of an underwater transceiver 1 in an embodiment.

FIG. 4 is a diagram showing an example of a functional configuration of a control unit 11 in an embodiment.

FIG. 5 is a diagram showing an example of the flow of processing executed by the underwater transceiver 1 in an embodiment.

FIG. 6 is a diagram illustrating an example of a hardware configuration of an aerial transceiver 2 in an embodiment.

FIG. 7 is a diagram showing an example of a functional configuration of a control unit 21 in the embodiment.

FIG. 8 is a diagram showing an example of the flow of processing executed by the aerial transceiver 2 in an embodiment.

FIG. 9 is a diagram showing an example of the flow of processing executed by the communication system 100 in an embodiment.

### DESCRIPTION OF EMBODIMENTS

### First Embodiment

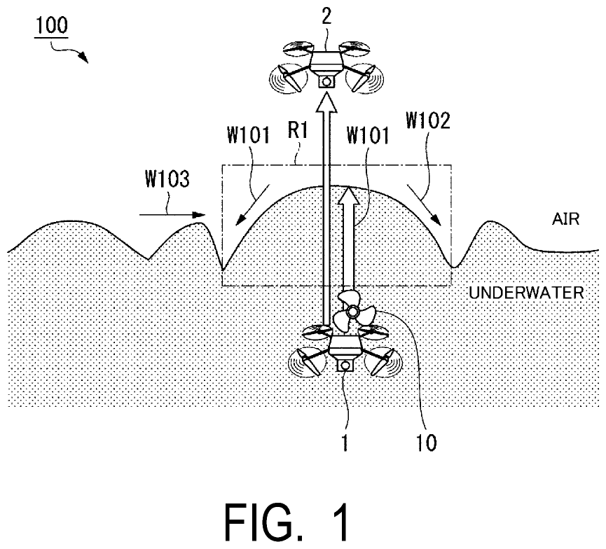

FIG. 1 is an explanatory diagram for describing an overview of a communication system 100 in an embodiment. The communication system 100 includes an underwater transceiver 1 and an aerial transceiver 2. In the communication system 100, the underwater transceiver 1 and the aerial transceiver 2 exchange information wirelessly. A signal may be carried by any wave as long as it is a radio signal. For this reason, a signal may be carried by light, by electromagnetic waves other than light such as radio waves, or by sound waves. Hereinafter, for the sake of simplicity, the communication system 100 will be described with a case in which signals are carried by light as an example.

The underwater transceiver 1 acquires underwater information and transmits the acquired information to the aerial transceiver 2. The underwater transceiver 1 may or may not be a moving object. Hereinafter, for the sake of simplicity, the communication system 100 will be described with a case in which the underwater transceiver 1 is a moving object as an example.

The underwater transceiver 1 includes a water flow generator 10. The water flow generator 10 generates a water flow. The water flow generator 10 is, for example, a water flow pump. A water flow F101 in FIG. 1 is an example of a water flow generated by the water flow generator 10.

The underwater transceiver 1 generates a water flow by using the water flow generator 10, and thereby forms a convex portion on the water surface (which will be referred to as a “water surface convex portion” below). The shape of the water surface convex portion is substantially the same as the shape of a mountain with a crest, for example. A region R1 in FIG. 1 is an example of a water surface convex portion. The direction of the water flow generated by the water flow generator 10 may be any direction as long as it is a direction in which a convex portion can be formed on the water surface, for example, the direction toward the water surface.

The underwater transceiver 1 does not necessarily have to have only one water flow generator 10, but may have a plurality of water flow generators 10. In such a case, each water flow generator 10 may generate a water flow so that a convex portion is formed on the water surface as a result of water flows generated by each of the water flow generators 10 interfering with each other. Since the water flow is also waves, the water flow generator 10 generates the water flow, for example, by controlling the phase and strength of the waves to form a convex portion on the water surface.

The underwater transceiver 1 transmits a signal in a direction from underwater to the air that is the direction toward the water surface convex portion. The underwater transceiver 1 transmits a radio signal, for example, in a direction from underwater to the air that is the direction from underwater to the vicinity of the center of the water surface convex portion.

The aerial transceiver 2 is located in the air and receives the information transmitted by the underwater transceiver 1. The aerial transceiver 2 may or may not be a moving object. Hereinafter, for the sake of simplicity, the communication system 100 will be described with a case in which the aerial transceiver 2 is a moving object as an example.

Role of Water Surface Convex Portion

The role of a water surface convex portion in the communication system 100 will now be described. More specifically, the influence of a water surface convex portion on the transmission and reception of signals between the underwater transceiver 1 and the aerial transceiver 2 will be described.

A water surface convex portion is a region of a wave higher than the surrounding sea surface. For this reason, a flow is generated from the water surface convex portion toward the surroundings. Each of flows W101 and W102 in FIG. 1 is an example of a flow from the water surface convex portion to the surroundings. Because the flow is generated from the water surface convex portion toward the surroundings, the intrusion of the nearby waves into the water surface convex portion is prevented. A wave W103 in the figure is an example of a nearby wave. Because the intrusion of the nearby wave into the water surface convex portion is prevented, the fluctuation generated on the water surface by the nearby wave is reduced in the water surface convex portion.

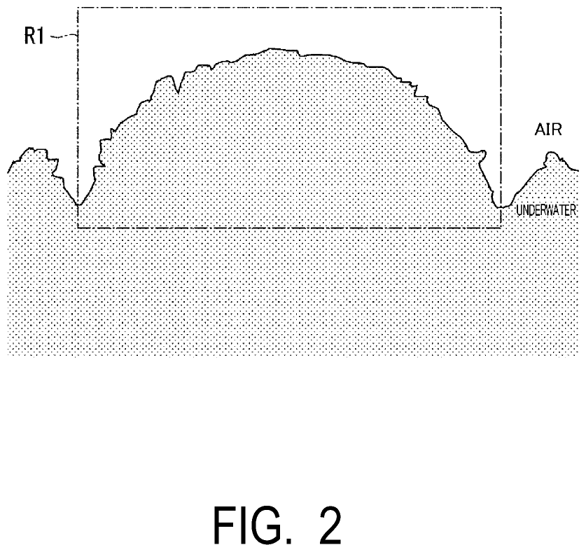

FIG. 2 is a diagram illustrating an example of an enlarged view of a water surface convex portion in an embodiment. FIG. 2 shows a fluctuation of the height of a water surface in a shorter period compared to a change of the height of the water surface of a convex portion on the water surface of a water surface convex portion. In this way, a fluctuation of a short wavelength occurs on the sea surface of the water surface convex portion. However, the fluctuation caused by the nearby wave is reduced compared to the case in which there is no water surface convex portion, and the wavelength of the fluctuation is shorter compared to the case in which there is no water surface convex portion. The wavelength of the fluctuation is several cm to 10 cm, for example, when the water surface is the sea surface.

In communication between the underwater transceiver 1 and the aerial transceiver 2, a signal transmitted by the underwater transceiver 1 is scattered more on the water surface as the fluctuation occurs more, and it becomes difficult for it to reach the aerial transceiver 2. As a result, the intensity of the signal received by the aerial transceiver 2 in a unit time is reduced, and a burst error occurs while the aerial transceiver 2 cannot receive sufficient light required for data transmission.

However, when light having a beam diameter greater than the wavelength of a fluctuation is used for carrying a signal, the influence of scattering caused by the water surface is reduced, and reduction of the intensity of a signal received by the aerial transceiver 2 in a unit time is prevented. That is, the condition for improving the stability of communication is that light having a beam diameter greater than the wavelength of a fluctuation is used for carrying a signal (which is referred to as a “communication stability condition” below). Further, a beam diameter is the extent of the spread of an intensity distribution in a plane perpendicular to the traveling direction of a wave such as light carrying a signal.

When there is a water surface convex portion, the wavelength of the fluctuation is shorter than that when there is no water surface convex portion, and thus the minimum value of the beam diameter satisfying the communication stability condition is smaller than that when there is no water surface convex portion. The greater a beam diameter, the larger the size of devices on the signal transmission side. An example of an increasing size of devices on the signal transmission side is, for example, an increase in the number of signal transmitters. Thus, the communication system 100 can curb an increasing size of devices on the signal transmission side compared to the case in which there is no water surface convex portion.

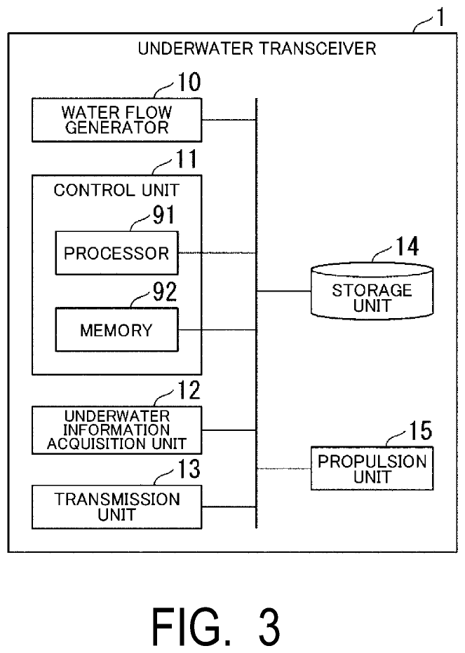

FIG. 3 is a diagram illustrating an example of a hardware configuration of the underwater transceiver 1 in an embodiment. The underwater transceiver 1 includes a control unit 11 including a processor 91 such as a central processing unit (CPU) and a memory 92, which are connected by a bus, and executes a program. The underwater transceiver 1 functions as a device including the water flow generator 10, the control unit 11, an underwater information acquisition unit 12, a transmission unit 13, a storage unit 14, and a propulsion unit 15 by executing a program.

More specifically, the underwater transceiver 1 causes the processor 91 to read a program stored in the storage unit 14 and store the read program in the memory 92. Due to the processor 91 executing the program stored in the memory 92, the underwater transceiver 1 functions as a device including the water flow generator 10, the control unit 11, the underwater information acquisition unit 12, the transmission unit 13, the storage unit 14, and the propulsion unit 15.

The control unit 11 controls operations of each of the units included in the underwater transceiver 1. The control unit 11 controls, for example, an operation of the water flow generator 10 to cause the water flow generator 10 to generate a water flow. The control unit 11 records, for example, information acquired by the underwater information acquisition unit 12 in the storage unit 14. The control unit 11 controls, for example, an operation of the transmission unit 13. The control unit 11 controls, for example, an operation of the propulsion unit 15.

The underwater information acquisition unit 12 includes sensors for acquiring underwater information such as water pressure, water temperature, and a salt concentration. The underwater information acquisition unit 12 may be configured as an interface for connecting such sensors to the underwater transceiver 1.

The transmission unit 13 emits light for carrying a signal with a beam diameter satisfying the communication stability condition (which will be referred to as “signal light” below). The transmission unit 13 may be of any type as long as it can emit light for carrying a signal with a beam diameter satisfying the communication stability condition. The transmission unit 13 may include a plurality of transmitters for emitting light for carrying a signal, for example. Emission of signal light by the transmission unit 13 is transmission of a signal by the transmission unit 13 to the aerial transceiver 2.

The transmission unit 13 is arranged in a direction in which emitted light is directed toward a water surface convex portion. Thus, the light emitted by the transmission unit 13 is directed to the water surface convex portion.

The storage unit 14 is configured by using a non-transitory computer-readable storage medium device such as a magnetic hard disk device or a semiconductor storage device. The storage unit 14 stores various kinds of information about the underwater transceiver 1. The storage unit 14 stores, for example, programs for controlling operations of each of the units included in the underwater transceiver 1 in advance. The storage unit 14 stores, for example, information acquired by the underwater information acquisition unit 12.

The propulsion unit 15 gives a propulsion force to the underwater transceiver 1. The propulsion unit 15 is, for example, a screw.

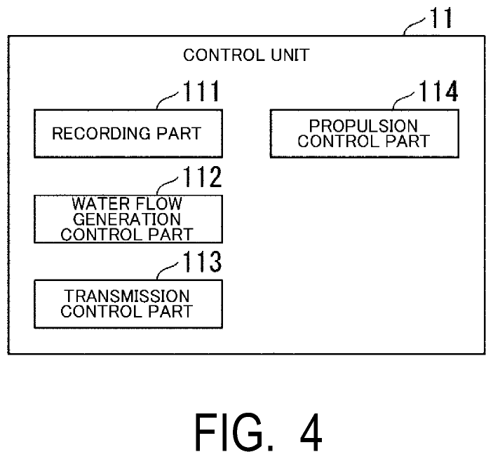

FIG. 4 is a diagram illustrating an example of a functional configuration of the control unit 11 in an embodiment. The control unit 11 includes a recording part 111, a water flow generation control part 112, a transmission control part 113, and a propulsion control part 114.

The recording part 111 records various types of information in the storage unit 14. The recording part 111 records, for example, information acquired by the underwater information acquisition unit 12 in the storage unit 14. The water flow generation control part 112 controls operations of the water flow generator 10. The transmission control part 113 controls operations of the transmission unit 13. The propulsion control part 114 controls operations of the propulsion unit 15.

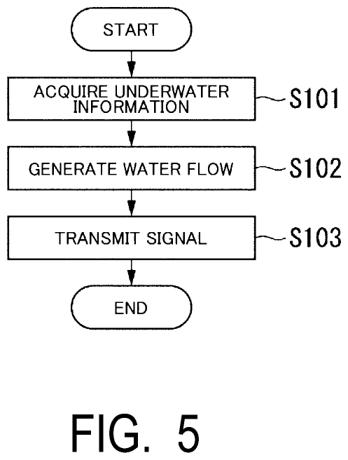

FIG. 5 is a diagram showing an example of the flow of processing executed by the underwater transceiver 1 in an embodiment. The underwater information acquisition unit 12 acquires underwater information (step S101). Next, the water flow generation control part 112 controls the operation of the water flow generator 10 to cause the water flow generator 10 to generate a water flow (step S102). A water surface convex portion is formed on the water surface through the execution of the processing of step S102. Next, the transmission control part 113 controls the operation of the transmission unit 13 to cause the transmission unit 13 to transmit a signal indicating the underwater information (step S103). That is, under the control of the transmission control part 113, the transmission unit 13 emits light carrying the underwater information. The light emitted in step S103 propagates through the water toward the water surface convex portion.

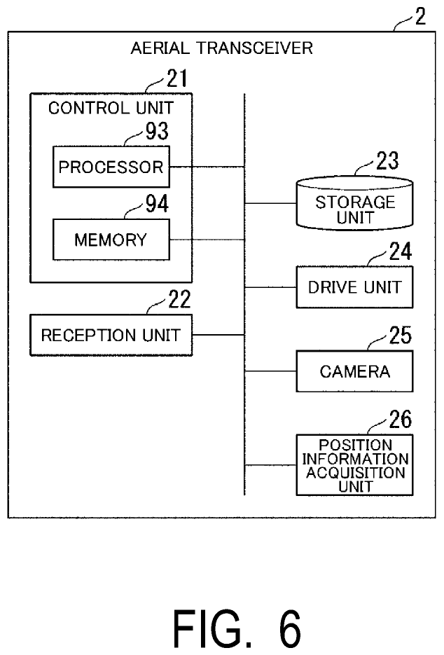

FIG. 6 is a diagram illustrating an example of a hardware configuration of the aerial transceiver 2 in an embodiment. The aerial transceiver 2 includes a control unit 21 including a processor 93 such as a central processing unit (CPU) and a memory 94, which are connected by a bus, and executes a program. The aerial transceiver 2 functions as a device including the control unit 21, a reception unit (receiver) 22, a storage unit 23, a drive unit 24, a camera 25, and a position information acquisition unit 26 by executing a program.

More specifically, the aerial transceiver 2 causes the processor 93 to read a program stored in the storage unit 23 and store the read program in the memory 94. Due to the processor 93 executing the program stored in the memory 94, the aerial transceiver 2 functions as a device including the control unit 21, the reception unit 22, the storage unit 23, the drive unit 24, the camera 25, and the position information acquisition unit 26.

The control unit 21 controls operations of each of the units included in the aerial transceiver 2. For example, the control unit 21 controls the operation of the drive unit 24 to cause the aerial transceiver 2 to move. The control unit 21 controls, for example, an operation of the reception unit 22. The control unit 21 records, for example, information acquired by the reception unit 22 in the storage unit 23. The control unit 21 controls, for example, operations of the drive unit 24, the camera 25, and the position information acquisition unit 26 to move the device (the aerial transceiver 2) to a water surface convex portion.

The reception unit 22 receives a signal transmitted by the underwater transceiver 1. That is, the reception unit 22 receives light emitted by the underwater transceiver 1.

The storage unit 23 is configured by using a non-transitory computer-readable storage medium device such as a magnetic hard disk device or a semiconductor storage device. The storage unit 23 stores various kinds of information about the aerial transceiver 2. The storage unit 23 stores, for example, programs for controlling operations of each of the units included in the aerial transceiver 2 in advance. The storage unit 23 stores, for example, information acquired by the reception unit 22. The storage unit 23 stores values of external parameters and internal parameters of the camera 25 such as a direction and an angle of view of the camera 25 in advance.

The drive unit 24 gives a propulsion force to the aerial transceiver 2. The drive unit 24 is, for example, a propeller.

The camera 25 is a camera that images a water surface. The position information acquisition unit 26 acquires information indicating a position of the aerial transceiver 2 by using a positioning technique capable of acquiring information indicating a position of the device (the aerial transceiver 2), such as the Global Positioning System (GPS). Hereinafter, information indicating a position will be referred to as “position information”.

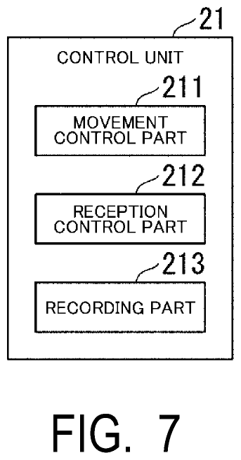

FIG. 7 is a diagram illustrating an example of a functional configuration of the control unit 21 in an embodiment. The control unit 21 includes a movement control part 211, a reception control part 212, and a recording part 213. The movement control part 211 controls movement of the aerial transceiver 2. Specifically, the movement control part 211 controls movement of the aerial transceiver 2 by controlling the operations of the drive unit 24, the camera 25 and the position information acquisition unit 26.

More specifically, for example, the movement control part 211 first estimates the position of an underwater convex portion based on an image captured by the camera 25 and position information acquired by the position information acquisition unit 26. The estimation is performed, for example, by executing estimation processing. In the estimation processing, first, the position information of the aerial transceiver 2 is acquired by using the position information acquisition unit 26. In the estimation processing, it is determined whether there is a pattern of an underwater convex portion in the captured image based on the pattern on the water surface in the captured image.

If there is a pattern of an underwater convex portion in the image in the estimation processing, a pixel projecting the underwater convex portion in the image is determined. The pattern of the underwater convex portion is a pattern satisfying a condition for an underwater convex portion pattern. The condition for an underwater convex portion pattern is a predetermined condition that a pattern appearing in a captured image in which an underwater convex portion is photographed satisfies. Thus, a pixel reflecting an underwater convex portion pattern is a pixel reflecting an underwater convex portion.

Next in the estimation processing, information indicating the position of the underwater convex portion on the earth is acquired by using the position information of the aerial transceiver 2, each value of the external parameter and the internal parameter of the camera 25, and information indicating the pixel reflecting the underwater convex portion.

The movement control part 211 then controls the operation of the drive unit 24 so as to bring the aerial transceiver 2 close to the position of the underwater convex portion based on the information indicating the position of the underwater convex portion on the earth estimated in the estimation processing and the position information of the aerial transceiver 2 acquired by using the position information acquisition unit 26. Under the control of the movement control part 211, the aerial transceiver 2 moves to a position on the underwater convex portion such as a position right above the underwater convex portion.

The reception control part 212 controls operations of the reception unit 22. The reception control part 212 controls an operation of the reception unit 22 to acquire information transmitted by the underwater transceiver 1.

The recording part 213 records various types of information in the storage unit 23. The recording part 213 records, for example, information acquired by the reception unit 22 in the storage unit 23. The recording part 213 records, for example, information indicating a position of the aerial transceiver 2 acquired by the position information acquisition unit 26 in the storage unit 23.

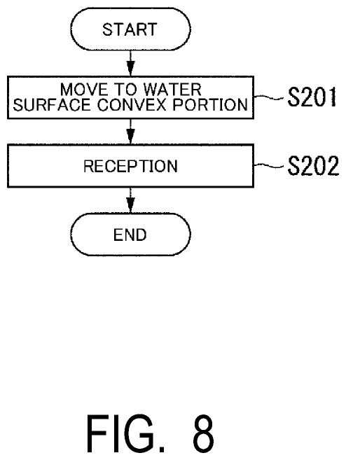

FIG. 8 is a diagram showing an example of the flow of processing executed by the aerial transceiver 2 in an embodiment. The movement control part 211 moves the aerial transceiver 2 to a position above a water surface convex portion (step S201). Next, the reception control part 212 controls an operation of the reception unit 22 to cause the reception unit 22 to receive a signal transmitted by the underwater transceiver 1 (step S202). That is, under the control of the reception control part 212, the reception unit 22 receives light carrying underwater information. Because the aerial transceiver 2 receives the light through step S201 as described above, the light received by the reception unit 22 is light transmitted through an underwater convex portion.

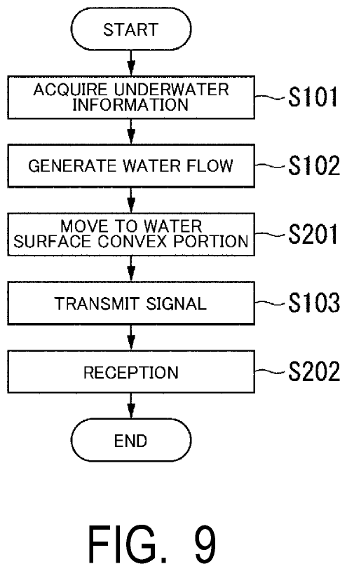

FIG. 9 is a diagram showing an example of the flow of processing executed by the communication system 100 in an embodiment. For the sake of simplicity of description, the same processing as that shown in FIG. 5 or FIG. 8 will be denoted by the same reference numerals as those in FIG. 5 or FIG. 8, and description thereof will be omitted.

The processing of step S102 is executed after step S101. Next, the processing of step S201 is executed. Next, the processing of step S103 is executed. Next, the process of step S202 is executed.

Further, the timing at which the underwater transceiver 1 executes the processing of step S103 is, for example, after the processing of step S102 is executed and then a predetermined time elapses. Further, the timing at which the underwater transceiver 1 executes the processing of step S103 may be a predetermined timing, for example, every hour.

Further, step S103 may be executed after the execution of step S102 and before the execution of step S201. In this case, the processing of step S103 is continuously repeated until the processing of step S202 is completed.

The communication system 100 configured in this way includes the underwater transceiver 1 that forms a water surface convex portion and transmits a signal toward the formed water surface convex portion. Because a water surface convex portion helps reduction of fluctuations, a probability of signals transmitted by the underwater transceiver 1 being scattered on the water surface is reduced. Furthermore, since the wavelength of a fluctuation generated in a water surface convex portion is shorter than the wavelength of a fluctuation of the water surface with no water surface convex portion formed, the beam diameter of light for carrying a signal can be made shorter than that in the case with no water surface convex portion formed. Therefore, the communication system 100 can provide a technique for achieving both improvement in stability of communication when transmitting information from underwater to the air wirelessly and suppression of an increase in size of the device on the signal transmission side.

In addition, the underwater transceiver 1 as described above forms a water surface convex portion and transmits a signal toward the formed water surface convex portion. Therefore, the underwater transceiver 1 can provide a technique for achieving both improvement in stability of communication when transmitting information from underwater to the air wirelessly and suppression of an increase in size of the device on the signal transmission side.

### Modified Example

A water surface convex portion may have, for example, a convex lens shape. In such a case, the refractive index of water is higher than that of the air, and thus light emitted by the underwater transceiver 1 is concentrated in the air. Thus, if the aerial transceiver 2 is positioned at a position on which light emitted by the underwater transceiver 1 is concentrated, the intensity of an optical signal received by the aerial transceiver 2 in a unit time is equal to or higher than the intensity of light when no water surface convex portion is formed. Therefore, when the shape of the water surface convex portion is, for example, a convex lens shape, the stability of communication in the communication system 100 is improved.

Further, a shape formed on the water surface by the water flow generator 10 may not necessarily be convex. The water flow generator 10 may be of any type as long as it generates a water flow and can perform control such that the shape of a partial region on the water surface (which will be referred to as a “control region” below) has a shape capable of reducing fluctuations of the water surface in the control region. The water flow generator 10 may form, for example, a concave water surface. Because the wavelength of a fluctuation generated in a water surface concave portion is shorter than the wavelength of a fluctuation of a water surface with no water surface concave portion formed, the beam diameter of light for carrying a signal can be made shorter than that in the case with no water surface concave portion formed. In addition, fluctuations of the water surface in the concave control region are reduced more than fluctuations of the water surface in regions around the control region. The concave shape is formed by, for example, the water flow generator 10 pulling in the water to generate a water flow from the water surface toward the water flow generator 10. In such a case, the water flow generator 10 emits light toward the concave control region. More specifically, the water flow generator 10 emits light toward the bottom of the valley of the concave shape, for example.

As described above, the water surface convex portion is an example of the control region, and the concave region on the water surface is an example of the control region. In addition, a water surface convex portion is a region on a water surface where a flow of water flowing to the outside from a control region occurs. A concave control region is a region where a flow of water flowing into a control region from the outside occurs. Therefore, more specifically, a shape of a control region is a shape capable of generating only one of a flow of water flowing to the outside from the control region and a flow of water flowing into the control region from the outside. In addition, a signal transmitted by the transmission unit 13 is emitted toward the control region. The water surface convex portion is an example of a control region.

As described above, the underwater transceiver 1 does not necessarily have to be a moving object. When the underwater transceiver 1 is not a moving object, the underwater transceiver 1 does not necessarily have to include the propulsion unit 15 and the propulsion control part 114.

As described above, the aerial transceiver 2 does not necessarily have to be a moving object. When the aerial transceiver 2 is not a moving object, the aerial transceiver 2 does not necessarily have to include the drive unit 24, the camera 25, the position information acquisition unit 26, and the movement control part 211.

Further, the underwater transceiver 1 does not necessarily acquire only underwater information, and the underwater transceiver 1 may acquire various types of information such as information of the underwater transceiver 1 itself. In addition, the underwater transceiver 1 does not necessarily have to transmit underwater information to the aerial transceiver 2. Information transmitted from the underwater transceiver 1 to the aerial transceiver 2 may be any type of information. The aerial transceiver 2 may not necessarily acquire underwater information as long as it is information transmitted by the underwater transceiver 1.

Further, a timing at which the underwater transceiver 1 transmits a signal may be, for example, after the following response confirmation timing. The response confirmation timing is a timing at which, after the underwater transceiver 1 transmitted a test signal toward a water surface convex portion, the underwater transceiver 1 receives a response signal which is a signal transmitted by the aerial transceiver 2 that has received the test signal and transmitted from the aerial transceiver 2 toward the water surface convex portion. The response signal is, for example, a radio signal such as light. With respect to the underwater transceiver 1, the underwater transceiver 1 transmits a data signal toward a water surface convex portion after the response confirmation timing. That is, the underwater transceiver 1 confirms the response signal and transmits the data signal toward the water surface convex portion. Further, because the response signal is more surely propagated toward the underwater transceiver 1 as the beam diameter is larger, it is desirable that the response signal transmitted by the aerial transceiver 2 has a larger beam diameter.

The underwater transceiver 1 is an example of a wireless communication device. The communication system 100 is an example of a wireless communication system. The transmission unit 13 is an example of an emission unit (emitter). A signal transmitted by the underwater transceiver 1 is an example of a signal for carrying information by using a wave.

The communication system 100 may be implemented using a plurality of information processing devices communicatively connected via a network. In this case, each functional unit included in the communication system 100 may be implemented in a distributed manner across a plurality of information processing devices.

Further, some or all of the functions of the communication system 100, the underwater transceiver 1, and the aerial transceiver 2 may be realized by using hardware such as an application specific integrated circuit (ASIC), a programmable logic device (PLD), or a field programmable gate array (FPGA). A program may be recorded in a computer-readable recording medium. The computer-readable recording media are, for example, portable media such as flexible disks, magneto-optical disks, ROMs, CD-ROMs and storage devices such as hard disks built into computer systems. The program may be transmitted via telecommunication lines.

Although the embodiments of the present invention have been described in detail with reference to the drawings, specific configurations are not limited to these embodiments, and designs and the like within a range that does not deviating from the gist of the present invention are also included.

### REFERENCE SIGNS LIST

100 Communication system
1 Underwater transceiver
2 Aerial transceiver
10 Water flow generator
11 Control unit
12 Underwater information acquisition unit
13 Transmission unit
14 Storage unit
15 Propulsion unit
111 Recording part
112 Water flow generation control part
113 Transmission control part
114 Propulsion control part
21 Control unit
22 Reception unit
23 Storage unit
24 Drive unit
25 Camera
26 Position information acquisition unit
211 Movement control part
212 Reception control part
213 Recording part
91 Processor
92 Memory
93 Processor
94 Memory

1. A wireless communication device comprising:
a water flow generator configured to control a shape of a partial region on a water surface; and
an emitter configured to emit a wave carrying information toward the region.

2. The wireless communication device according to claim 1, wherein a shape of the region controlled by the water flow generator is a shape capable of generating only one of a flow of water flowing to the outside from a control region and a flow of water flowing into the control region from the outside.

3. The wireless communication device according to claim 1, wherein the shape of the region is convex.

4. The wireless communication device according to claim 1, wherein a beam diameter of a wave emitted by the emitter is longer than a wavelength of a fluctuation generated in the region.

5. A wireless communication system comprising:
a water flow generator configured to control a shape of a partial region on a water surface; an emitter configured to emit a wave carrying information toward the region; and
a receiver configured to receive a signal carrying information using the wave.

6. A wireless communication method comprising:
controlling a shape of a partial region on a water surface; and
emitting a wave carrying information toward the region.

7. The wireless communication device according to claim 2, wherein the shape of the region is convex.

8. The wireless communication device according to claim 2, wherein a beam diameter of a wave emitted by the emitter is longer than a wavelength of a fluctuation generated in the region.

9. The wireless communication device according to claim 3, wherein a beam diameter of a wave emitted by the emitter is longer than a wavelength of a fluctuation generated in the region.
